(19) United States
(12) Patent Application Publication
(10) Pub. No.: US 2015/0074687 A1
(43) Pub. Date: Mar. 12, 2015

(54) METHODS AND APPARATUSES OF SWITCHING APPLICATIONS AND ADDING ENTRY INFORMATION

(71) Applicant: Alibaba Group Holding Limited, Grand Cayman (KY)

(72) Inventor: Jiangsheng Ji, Hangzhou (CN)

(21) Appl. No.: 14/483,037

(22) Filed: Sep. 10, 2014

(30) Foreign Application Priority Data
Sep. 11, 2013 (CN) 201310412730.8

(51) Int. Cl. G06F 9/445; G06F 9/54

(52) U.S. Cl. CPC G06F 9/445; G06F 9/542
USPC 719/318

(57) ABSTRACT

The present disclosure discloses methods and apparatuses of switching applications and adding entry information. The method includes: obtaining usage information of a user with respect to applications installed in a terminal, where the applications include one or more first applications and one or more second applications; and determining a second application associated with a first application based on the usage information to facilitate an addition of entry information of the associated second application to a running interface of the first application and to run the second application when the user executes a specified operation on the entry information of the associated second application. The present disclosure can save operation time of the user and reduce power consumption of a terminal device.

### CROSS REFERENCE TO RELATED PATENT APPLICATION

This application claims foreign priority to Chinese Patent Application No. 201310412730.8 filed on Sep. 11, 2013, entitled “Methods and Apparatuses of Switching Applications and Adding Entry Information”, which is hereby incorporated by reference in its entirety.

### TECHNICAL FIELD

The present disclosure relates to the field of running control technologies of application programs in terminal devices, and more particularly relates to methods and apparatuses of switching applications and adding entry information.

### BACKGROUND

As smart mobile devices become popular and mobile Internet technologies become mature, a large number of various applications have emerged.

In existing technologies, a home screen or desktop is usually provided by a management program such as an operating system. After a user has installed a favorite application, an icon of the installed application is displayed as an entry of the application on the home screen or desktop provided by the operating system, so that the user can use the corresponding application through the icon of the application. In other words, entries of various applications are located on the home screen or desktop provided by the operating system, so that when switching from a first application to a second application, the user usually needs to perform the following steps:

Step 1: Exit the first application that is currently used.

Step 2: Switch to an application interface or desktop provided by the operating system.

Step 3: Find entry information of the second application on the application interface or desktop provided by the operating system, such as an icon of the second application displayed on the application interface or desktop, and choose to run the second application.

In a process of performing the above operations, the user needs to switch to the home screen or desktop provided by the operating system, and find the icon of the second application on the home screen or desktop provided by the operating system. In the above process, the user needs to perform many manual operations, and if the user has installed a large number of applications, the user further needs to find the entry information of the corresponding second application from among entry information, such as a large amount of application icons, which causes a waste of time, affects user experience, and also increases power consumption of a terminal device.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

The present disclosure provides methods and apparatuses of switching applications and adding entry information, which can save operation time for a user, improve user experience, and reduce power consumption of a terminal device.

The present disclosure provides the following solutions:

An application switching method includes:

acquiring usage information of a user for applications installed in a terminal, the applications include one or more first applications and one or more second applications; and

determining a second application that is associated with a first application based on the acquired usage information, so as to add entry information of the associated second application into a running interface of the first application to facilitate running of the second application when the user executes a specified operation on the entry information of the associated second application.

An application switching method includes:

running a first application, a running interface of the first application including entry information of a second application that is associated with the first application for facilitating running the second application when a specified operation is executed on the entry information of the associated second application, where

the second application that is associated with the first application is determined using the following approach:

acquiring usage information of a user for applications installed in a terminal, the applications including the first application and one or more second applications; and

determining, based on the acquired usage information, the second application that is associated with the first application.

A method for adding entry information into an application running interface includes reserving one or more entry information windows on a running interface of a first application, and adding entry information of at least one second application that is associated with the first application to the entry information windows, where the at least one second application that is associated with the first application is determined based on an order of using the first application and the second application by a user.

An application switching apparatus includes:

a usage information acquisition unit, used for acquiring usage information of a user for applications installed in a terminal, the applications including one or more first applications and one or more second applications; and

an associated application determination unit, used for determining, based on the acquired usage information, a second application that is associated with a first application, so as to add entry information of the associated second application into a running interface of the first application to facilitate running of the second application when the user executes a specified operation on the entry information of the associated second application.

An application switching apparatus includes:

a running unit, used for running a first application, a running interface of the first application including entry information of a second application that is associated with the first application, so as to facilitate running of the second application when a specified operation is executed on the entry information of the associated second application, where

the second application that is associated with the first application is determined using the following approach:

a usage information acquisition unit, used for acquiring usage information of a user for applications installed in a terminal, the applications including the first application and one or more second applications; and

an associated application determination unit, used for determining, based on the acquired usage information, the second application that is associated with the first application.

An apparatus for adding entry information to an application running interface is provided, where one or more entry information windows are reserved on a running interface of a first application. The apparatus is used for adding entry information of at least one second application that is associated with the first application into the entry information windows, where the at least one second application that is associated with the first application is determined based on an order of using the first application and the second application by a user.

According to the specific embodiments provided by the present disclosure, the present disclosure discloses the following technical effects:

By using the embodiments of the present disclosure, usage information of a user for applications installed in a terminal can be acquired so that a second application that is associated with a first application can further be determined and an entry of the second application is provided in a running interface of the first application. In this way, the a user intends to use a certain second application after using the first application, the user can directly use an entry displayed on the running interface of the current first application to switch to the second application and run the second application, without executing such operation as switching to a home screen or desktop of an operating system, thus saving the user from finding the second application from among various application icons on the home screen or desktop. This reduces operation time for the user, improves user experience, and also reduces power consumption of a terminal device.

Certainly, any product implementing the present disclosure does not need to achieve all the foregoing advantages at the same time.

### BRIEF DESCRIPTION OF THE DRAWINGS

In order to describe the technical solutions of the embodiments of the present disclosure or the existing technologies more clearly, the accompanying drawings used for describing the embodiments are described briefly. The accompanying drawings described hereinafter are merely some embodiments of the present disclosure. One of ordinary skill in the art may still derive other drawings from these accompanying drawings without performing any creative efforts.

FIG. 1 is a flowchart of a method according to an embodiment of the present disclosure.

FIG. 2 is a schematic diagram of displaying in a running interface of an application entry information of other applications according to an embodiment of the present disclosure.

FIG. 3 is a schematic diagram of an apparatus according to an embodiment of the present disclosure.

FIG. 4 is a schematic diagram of another apparatus according to an embodiment of the present disclosure.

FIG. 5 is schematic diagram of the apparatus described in FIGS. 3 and 4 in further details.

### DETAILED DESCRIPTION

The technical solutions of the embodiments of the present disclosure are described hereinafter in a clear and comprehensive manner in conjunction with the accompanying drawings. The embodiments to be described are merely a part but not all of the embodiments of the present disclosure. All other embodiments obtained by one of ordinary skill in the art based on the embodiments of the present disclosure shall fall within the protection scope of the present disclosure.

In the embodiments of the present disclosure, in order to facilitate a user to switch from one application to another application, a running interface of another application may display an entry of another application. As such, after a user finishes using a current application, the user can directly execute an operation, such as a clicking operation, on the entry of the other application on a current running interface and switch to the other application for running, without exiting the current application first and searching for an icon of the other application in a home screen or desktop of an operating system. Exemplary implementations are introduced in detail herein.

### First Embodiment

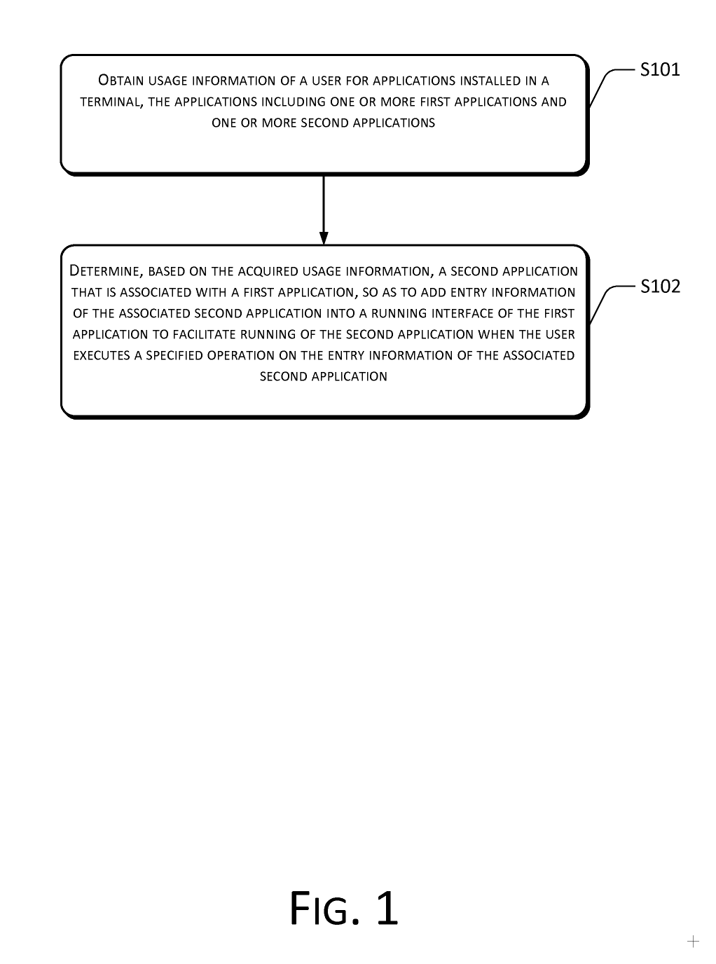

Referring to FIG. 1, an embodiment of the present disclosure provides an application switching method. The method may include the following blocks:

S101: Obtain usage information of a user for applications installed in a terminal, the applications including one or more first applications and one or more second applications.

The technical solution provided by the embodiment of the present disclosure may be implemented via an acquisition program that is installed in a terminal device. The acquisition program may be provided as an optional functionality of an operating system. When a user chooses to open the acquisition program, the acquisition program determines information related to the user's usage of applications installed in the terminal. In a specific implementation, the acquisition program provided by the embodiment of the present disclosure may be registered with the operating system. When the user uses a certain application, the operating system may send a notification message to the acquisition program, where the notification message includes an event of using the application by the user, and information such as an identifier of the application that is used. As such, the acquisition program can obtain, based on the notification message from the operating system, information about the user's usage of the applications installed in the terminal. The information about the user's usage of the applications may include information such as which applications are used by the user, and times that each application is used. Specific “use” may include opening, closing or stopping an application.

It should be noted that the acquisition program may acquire related usage information in real time based on a usage scenario of an application by the user. In other words, operations of using the application by the user are acquired in real time, and related usage information is recorded, which includes a name of the application that is used, time(s) of usage, etc. Alternatively, in another implementation, the acquisition program may further obtain the user's usage information of applications by recording information of the applications that are used by the user. For example, information of the user's usage of applications is obtained via log information of the applications that are used by the user. The log information may record information including application names and times of applications that the user has opened, stopped and closed. In short, in an embodiment of the present disclosure, information of user's usage of an application may be obtained in real time when the application is used by the user, or obtained from log information, etc., after the user uses the application based on the recorded log information.

S102: Determine, based on the acquired usage information, a second application that is associated with a first application, so as to add entry information of the associated second application into a running interface of the first application to facilitate running of the second application when the user executes a specified operation on the entry information of the associated second application.

In an embodiment of the present disclosure, the running interface of the first application may be a current interface, a configuration interface or other menu interface, etc., of the first application. In an embodiment of the present disclosure, the running interface of the first application is not limited to a specified interface as long as the running interface of the first application can enable the user to conveniently find the entry information of the second application.

In an embodiment of the present disclosure, the associated second application includes another application that may be used by the user after the user finishes using the first application. Such association is generally manifested by a usage habit of the user in a process of application usage, and therefore may be different for different users. In addition, a certain application may be associated with multiple other applications, and each application may have other application(s) that is/are associated therewith. For example, if a currently run application is an application A and a user A generally uses an application B after using the application A, an application that is associated with the application A is the application B with respect to the user A. If a user B generally uses an application C after using the application A, an application that is associated with the application A is the application C with respect to the user B.

For a certain user, multiple implementations are available for determining which application(s) is/are second application(s) associated with a first application. For example, in one implementation, a user may perform designation at his/her discretion. In other words, a configuration entry may be provided to the user in the acquisition program provided by the embodiment of the present disclosure, and the user can associate other application(s) with each application via the configuration entry. As such, upon finding that the user runs a certain application, a second application that is associated with that first application can be determined based on associated application(s) that is/are designated by the user in advance for that application in a process of application usage by the user.

Specifically, since this association relationship may be manifested by the usage habit of the user in a process of application usage, in one embodiment, the acquisition program provided by the embodiment of the present disclosure may collect the usage information of the user for various applications, and determine a second application that is associated with the first application based on the usage information. Specifically, the acquisition program may collect usage information of the user for the applications, and determine an application that is most likely to be used after the user has used the first application based on a statistical result, where this application may be recognized as the second application that is associated with the first application. For example, after a fiction application is used for reading, a user usually uses a music application to play music by using or plays a certain favorite game application, etc., a certain association may be determined to exist between the fiction application and the music application or game application based on this type of usage habit. In other words, if a user usually uses a second application after using a first application, this ordering relationship can manifest a usage habit of the user, and an association between applications can be determined accordingly.

Therefore, the following approach may be used to collect usage information of user for applications in order to determine an application that is associated with a first application during a process that the user uses the applications: recording log information associated with application usage of the user, where this log information of application usage may include information about times at which the applications are used; determining an order of using the applications based on the information of times at which the applications are used; and determining a second application that is associated with the first application based on the determined order of using the applications. For example, if a certain user is found to use an application B after using an application A, the application B may be determined as an application that is associated with the application A. It should be noted that information about an aforementioned order of use in the embodiment of the present disclosure includes a direct ordering relationship and/or an indirect ordering relationship. For example, if a user sequentially uses an application A, an application B, and an application C successively, a direct ordering relationship exists between the application A and the application B, and an indirect ordering relationship exists between the application A and the application C. Regardless of a direct ordering relationship or an indirect ordering relationship, a usage habit of the user is substantially manifested. It may be understood that for the user, the application B and the application C has an association relationship with the application A with respect to the user.

Information about a time at which an application is used may refer to a time at which the application is opened, a time at which the application is closed, a period of time during which the application is run, etc. For example, a time at which at application is opened is referred to, times at which the applications are opened may be individually recorded, and an order in which the applications are used may be determined according to an order of times at which the applications are opened. For example, if a certain user opens an application A at a moment T1, and subsequently opens an application B at a moment T2, an order of applications used by the user is determined as using the application A first and then switching to the application B based on a precedence relationship between T1 and T2. Similarly, if a user closes the application A at T1, and then opens or closes the application B at T2, an order of applications used by the user may also be determined to be from the application A to the application B based on a precedence relationship between T1 and T2. By the same token, if a user runs the application A in a time segment A1, and then runs the application B in a time segment A2, an order of applications used by the user may also be determined to be from the application A to the application B based on a precedence relationship between A1 and A2. In an embodiment, multiple second applications having this type of ordering relationship may exist. In other words, after using a first application A, a user may subsequently use a different second application, for example, an application C.

In an embodiment, a number of times of switching from one application to another application may be counted based on information of an order of applications used by a user. Based thereon, a process of determining a second application that is associated with a first application is performed. For example, based on an order of applications used by a user, a number of times that the user switches from a first application to a second application is counted. At least one second application having the number of times of switching among the highest is determined as the second application associated with the first application. The number of times of switching from one application to another application may be counted directly.

Furthermore, in order to exclude an influence of an accidental operation of the user on the counting, a switching threshold may be set up. When a number of times of switching from a first application to a second application reaches the switching threshold, the second application is recognized as an application that is associated with the first application in a process of application usage of the user. In other words, when the number of times of switching is not less than the set switching threshold, the procedure of determining the at least one second application having the number of times of switching among the highest as the second application associated with the first application is performed.

It should be noted that, when a user uses applications through a terminal device, generally only a precedence order associated with opening a second application shortly after the user exits the first application has a reference value. For example, after a certain user uses an application A, the user locks a screen of a terminal device, and takes up the terminal device to use an application B after a relatively long period of time. In this case, the application B would not be considered as an application that may be used by the user after using the application A. However, as far as an order in which applications are used is concerned, a switching relationship between the application A and the application B is also recorded, which may impact determination of an association relationship between applications. Therefore, in order to avoid the occurrence of this type of false determination, a time length threshold may be further set up in advance when switching relationships among applications are counted based on information of times at which the applications are used. If a time interval between respective times of using two certain applications is greater than this threshold, a switching relationship between the applications may be excluded from the counting.

The counting process in the embodiment of the present disclosure is further described hereinafter through an example. For example, a terminal device includes applications A, B, C, D, and E. The various orders of using the applications by a user A via the terminal device are as follows:

ACBDE, FACE, DEAC, CADE, and ACEDA.

A number of times that the user A switches from one application to another application may be computed based on the above usage information. For the sake of brevity, in the embodiment of the present disclosure, only direct ordering relationships among applications are counted, and an indirect ordering relationship between applications may be counted into numbers of times associated with the direct sequential relationships through an approach such as weight values. For example, in ACB, A is switched to B for a*1 times, where a is a weight, which value is in a negative correlation with the number of applications between A and B, i.e., the more the number of applications therebetween are, the less the value of a is. A specific value thereof may be greater than zero and less than one. For example, if only an application C exists therebetween, the value of a is set to be 0.5, i.e., the number of times is converted to 0.5*1=0.5 times. If more applications exist therebetween (e.g., applications C and D exist therebetween in a sequence ACDB), the value of a in this case may be set as 0.2, for example. Table 1 below only counts direct ordering relationships that exist among the applications.

TABLE 1

| | A | B | C | D | E |
|---|---|---|---|---|---|
| A | | 0 | 4 | 2 | 0 |
| B | 0 | | 0 | 1 | 0 |
| C | 1 | 1 | | 0 | 3 |
| D | 1 | 0 | 0 | | 2 |
| E | 2 | 0 | 0 | 1 | |

As can be seen from Table 1, the user A switches from the application A to the application C for four times, switches from the application A to the application D for two times, and switches from the application C to the application E for three times. In other words, after using the application A, the user A switches to the application C for four times, and switches to the application D for two times. After using the application C, the user A switches to the application E for three times. The number of times of switching between remaining applications are one and are relatively low. An association between the application A and the application C and an association between the application C and the application E are relatively strong. Therefore, for the application A, the application C may be determined as an application that is associated with the application A during the process of using the applications by the user A, and the application E may be determined as an application that is associated with the application C during the process of using the applications by the user A. “Zero” in Table 1 indicates that no related switching exists. For example, the number of times of switching from the application A to the application B is zero. A cell having no value in Table 1 indicates that there is no statistical significance. For example, there is no statistical significance for switching from the application A to the application A, and therefore a cell thereof is null.

After obtaining an application associated with a first application in the process of using applications by a user through performing the above counting operation, the associated application may be directly determined as the associated second application. Alternatively, associated applications obtained thereby may be provided to the user for selection, and if the user selects one or more applications from the associated applications, the application(s) selected by the user is/are determined as the second application(s) that is/are associated with the first application in the process of using the applications by the user.

As can be seen from the above, in the foregoing embodiment, an association relationship between applications is determined based on characteristics manifested from an order of using the applications by a user.

In real applications, the characteristics of application usage by a user usually differ in terms of time ranges. For example, for a same application A, the user usually uses an application B after using the application A in the morning, but often uses an application C after using the application A in the afternoon or evening, etc. Therefore, in order to enable a determined association relationship between applications to reflect a usage habit of the user more accurately, statistics may be further made based on time ranges. In other words, a number of time ranges, such as morning, afternoon, and evening, etc., may be specified in advance, and a determination is made as to which second application(s) is/are associated with a first application in each time range. Specifically, a second application associated with a first application in a specified time range is determined based on a statistical result, and entry information of the associated second application corresponding to that time range is added to a running interface of the first application in the specified time range. In an embodiment, the method of determining an association relationship between applications when performing statistics in each time range may be the same as that described above, and is not described in detail herein.

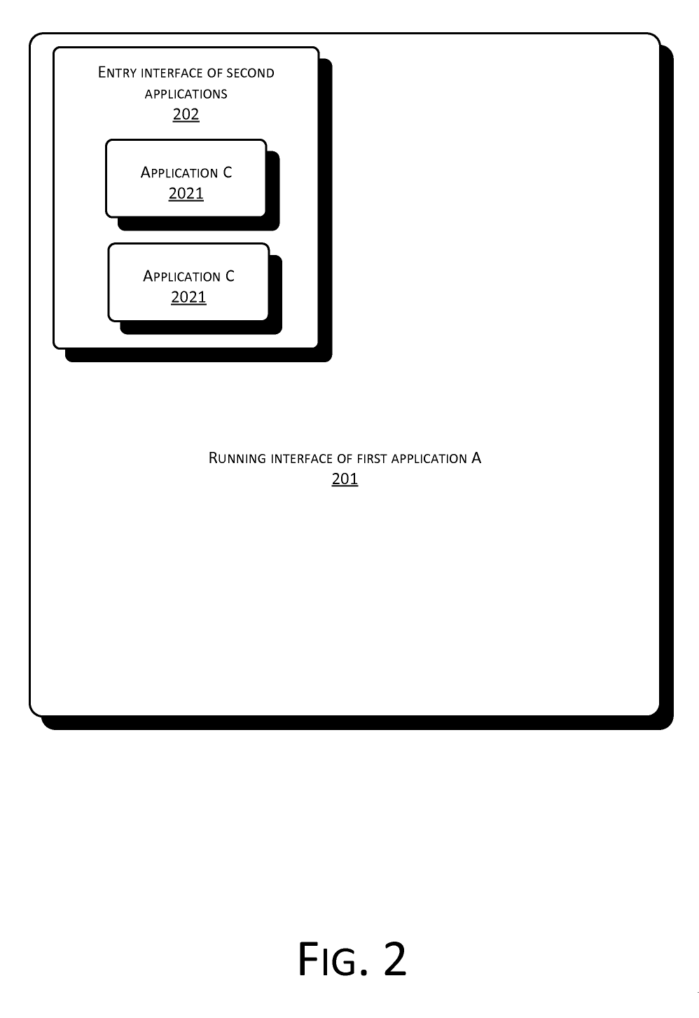

As shown in FIG. 2, if a currently run first application is an application A, a running interface 201 of the application A displays an entry interface 202 for second application(s) that is/are associated with the first application. If the second applications associated with the application A include an application C and an application D, entry information 2021 and 2022 of these two applications may be displayed on the entry interface 202. In other words, after determining the second applications associated with the first application, entry information of the second applications may be displayed on the running interface of the first application. The entry information is similar to that in existing technologies, and may include information including an application icon displayed on an application interface or desktop, such as icon information or a shortcut to the second application, etc. By performing an operation on entry information, a second application corresponding to the entry information is run. If the user wants to use a second application (e.g., the application C) after using the first application (i.e., the application A), the user may directly perform an operation (for example, a clicking or touching operation using a mouse or via a touch screen, etc., or even an operation associated with a defined gesture or action and the like) on entry information of the application C on the running interface of the current first application to switch to the application C and run the application C. The use does not need to perform such operation as switching to a home screen or desktop of an operating system and searching for the second application from among entry information such as various application icons on the home screen or desktop in the existing technologies. This saves operation time for the user, improves user experience, and also reduces power consumption of a terminal device.

Furthermore, in order to display entry information of a second application on a running interface of a first application, an association relationship between the first application and the second application may be further recorded in order to facilitate adding the entry information of the associated second application to the running interface of the first application based on the association relationship when the first application is run. Multiple implementation approaches are available for displaying the entry information of the second application on the running interface of the first application. For example, the entry information of the second application may be embedded into the running interface of the first application for display. Alternatively, a floating window may be displayed above the running interface of the first application, and the entry information of the second application is displayed in the floating window.

For the approach of embedding the entry information of the second application into the running interface of the first application for display, the process of displaying the entry information of the second application may be completed by the first application when implemented. In an embodiment, which application(s) is/are second application(s) associated with the first application is/are determined by the acquisition program in the embodiment of the present disclosure. During a specific implementation, the acquisition program may send, to a first application, information about a second application that is determined by the acquisition program to be associated with the first application, so that the first application can embed entry information of the second application into a running interface thereof for display. Multiple sending methods are available. For example, the acquisition program may monitor a running event of the first application, find a second application associated with the first application based on a recorded association relationship when the first application is found to start running, and send related information of an entry of the second application to the first application. Alternatively, under a circumstance that the first application has a process that runs in the background, the acquisition program may also initiatively send the second application determined thereby to be associated with the first application to the first application at any time moment before the first application is started. As such, the first application can store information about the second application associated therewith. When the first application is run, the second application that is associated with the first application can be found from information of a stored association relationship between applications, and add entry information of the found second application that is associated with the first application into the running interface of the first application.

In another implementation scenario, the first application may send a query request to the acquisition program. Upon receiving the request for querying an association from the first application, the acquisition program sends information about an associated second application to the first application to facilitate the first application to add entry information of the associated second application to a running interface of the first application.

In a specific implementation, in order to enable embedding the entry information of the second application into the running interface of the first application, the first application may reserve an entry information window on the running interface of the first application in advance, i.e., the first application specifies information such as an icon size and a position for placing the entry information on the running interface in advance, and integrates the entry information into the running interface as a part of the running interface. Since the first application may be associated with multiple second applications, in an embodiment, the acquisition program may further perform ordering of the second applications. For example, the second applications may be ranked according to respective degrees of associations with the first application, and these degrees may be manifested by respective numbers of times of switching from the first application to the second applications. In this case, entry information of associated second applications (which is sent by the acquisition program or found by the first application) obtained by the first application may further include ordering information of the second applications. As such, the first application may display respective entry information of the second applications on the entry information window according to this ordering information. In an embodiment, under a circumstance that the first application has reserved multiple entry information windows, a precedence relationship generally exists among the entry information windows. For example, if three entry information windows are reserved and are arranged from top to bottom, an order of precedence from the top to the bottom exists among the three entry information windows, for example. Therefore, after obtaining the order of the second applications, the entry information of the second applications may further be displayed in combination with the ordering relationship of the entry information windows. In an embodiment, the entry information of the second applications may also be placed according to degrees of prominence of the entry information windows. For example, when the entry information windows are not completely the same in size, a large entry information window has a higher degree of prominence than a small entry information window. Furthermore, an entry information window that is in the middle of the running interface has a higher degree of prominence than one that is at the edge. In this case, entry information of a second application that ranks high may be placed in an entry information window having a high degree of prominence.

In the implementation of displaying entry information of a second application in a floating window, the floating window may be created by a first application or by the acquisition program in the embodiment of the present disclosure, or even by another application of the operating system. In case when the first application or another application of the operating system provides the floating window, the acquisition program may use a communications mechanism to allow the first application or the other application of the operating system to obtain related entry information and add the entry information of an associated second application to the running interface of the first application for display (e.g., the acquisition program sends the related entry information of the second application, or the first application or the other application of the operating system stores, in the acquisition program, the related entry information of the second application that is associated with the first application). In case when the acquisition program creates the floating window, after determining the first application that is currently run, the acquisition program can find the entry information of the second application associated with the first application from a stored association relationship, and display the entry information in the floating window. In real applications, since the floating window is usually located above the running interface of the first application, the floating window may be further processed to be semi-transparent to avoid the occlusion of the floating window to affect the display of the running interface of the first application.

Multiple approaches are available for displaying entry information of a second application. For example, only an icon is displayed, i.e., the entry information of the second application viewed by a user may be the same as a viewed icon of the second application on the home screen or desktop. In an embodiment, a size of the icon may be adjusted according to a size of an entry information window, for example, scaling the icon for display. The user can click on the corresponding icon to realize the switching from the first application to the second application. Alternatively, in order to prevent an accidental operation of the user, a slider control plug-in may be added. The entry information of the second application may be displayed on a slider or at one end of a slider. The user drags the slider to achieve the switching from the first application to the second application. Alternatively, hint information such as an identifier of the second application may be displayed on the left or right hand side of a display interface of the first application, and the user directly switches to the second application and enters a running interface of the second application by sliding to the left or right on the display interface of the first application.

In addition, in an embodiment of the present disclosure, a rollback operation may be set for the first application when switching to run the second application, for example, suspending or terminating the running of the first application. When the user switches to the second application by using the entry information of the second application displayed on the running interface of the first application, the running of the first application is suspended or terminated correspondingly.

In an embodiment, a determination is made as to whether to suspend or terminate the first application when switching to the second application according to a characteristic associated with the running of the first application. For example, when a characteristic associated with running of a first application shows that the application (such as a game application or a video application) consumes much power and occupies a relatively large amount of resources such as storage and computation, etc., this type of first application may be automatically configured to be terminated from running, for example, closing or exiting, so as to release the resources occupied by the first application and thereby save the resources such as power, storage and computation of a terminal device. When the user re-opens this type of terminated first application, the first application needs to be run again. For a first application with a high frequency of use and a low power consumption (such as a reading-related application, etc.), the running of the application may be suspended. When the user switches back to this type of suspended first application, the running of the suspended first application can be restored immediately in order to further improve user experience.

It should be noted that, in terms of time, entry information of a second application may be added to a running interface of a first application after the user runs the first application, i.e., after finding that the user runs the first application and determining the second application that is associated with the first application, the entry information of the second application is added to the running interface of the first application. Alternatively, this may be performed in advance, i.e., even though the user has not opened the first application yet, one or more second applications associated with the first application can still be determined by means of a background operation, for example, so that after the user opens the first application, entry information of each second application may be directly displayed when other information is displayed on the running interface.

In short, in an embodiment of the present disclosure, by obtaining operation information of application usage of a user and determining a second application that is associated with a first application, entry information of the second application is provided in a running interface of the first application. In this way, if the user intends to use a certain second application after using the first application, the user can directly switch to the second application for running via the entry information displayed on the running interface of the current first application, without the need of performing an operation such as switching to a home screen or desktop of an operating system, thus avoiding an operation of searching for the second application from among various application icons on the home screen or desktop. This saves operation time for the user, improves user experience, and also reduces power consumption of a terminal device.

### Second Embodiment

As described in the first embodiment, when entry information of a second application is displayed on a running interface of a first application, a floating window may be used for display, or the entry information of the second application may be embedded into the running interface of the first application. For the latter case, a related operation of adding the entry information of the second application to the running interface of the first application may be performed by the first application. Therefore, in this second embodiment, a specific implementation thereof is introduced from the perspective of the first application.

The second embodiment of the present disclosure provides an application switching method. The method may include:

running a first application, a running interface of the first application including entry information of a second application that is associated with the first application to facilitating running of the second application when a specified operation is performed on the entry information of the associated second application, wherein

determining the second application that is associated with the first application is performed through the following:

acquiring usage information of a user for applications installed in a terminal, the applications including the first application and one or more second applications; and

determining the second application that is associated with the first application based on the acquired usage information.

In a specific implementation, in order to enable the first application to add the entry information of the second application to the running interface of the first application, the first application may receive information of the second application that is associated with the first application from the acquisition program at the time when the first application is running or at other occasions. When the first application is run, the entry information of the second application that is associated with the first application is loaded into the running interface of the first application.

Alternatively, the first application sends a query request to the acquisition program, and receives information of the second application associated with the first application that is returned from the acquisition program. When the first application is run, the entry information of the second application that is associated with the first application is loaded into the running interface of the first application.

Alternatively, the first application may obtain and store information of an association relationship between the first application and the second application from the acquisition program. When running, the first application may search for the second application associated with the first application from the stored information of the association relationship between the applications, and add entry information of the found second application that is associated with the first application into the running interface of the first application.

For other related implementations, reference may be made to the description in the first embodiment, which is not redundantly described herein.

### Third Embodiment

As described in the first embodiment, in order to implement an embedded display in a first application, the first application may reserve one or more entry information windows in a running interface thereof in advance. As such, after an associated second application is determined, entry information of the second application can be directly displayed in an entry information window. Description thereof is given as follows.

The third embodiment of the present disclosure provides a method of adding entry information to a running interface of an application. The method may include: reserving one or more entry information windows in a running interface of a first application, and adding entry information of at least one second application that is associated with the first application to an entry information window, where the at least one second application that is associated with the first application is determined based on an ordering relationship of using the first application and the second application by a user.

In a specific implementation, the one or more second applications that are associated with the first application may refer to a second application that is determined in the first embodiment or the second embodiment, i.e., the second application associated with the first application that is determined by acquiring operation information associated with the user's usage of applications. This includes other applications that are often used after the user has used the first application, etc. With respect to how to determine a precedence ordering relationship of using second applications of a user that is manifested during a process of application usage, the method introduced in the first embodiment may be used, and is not redundantly described herein. In an embodiment, in a real application, this second application may be another application having an association relationship with the first application in other aspects, e.g., an application having a function similar to that of the first application, etc.

After determining the second application that is associated with the first application, related information of the second application (for example, an identifier such as a name or icon information of the second application) may be sent to the first application. The first application may then display entry information of the second application in a reserved entry information window thereof.

Since the first application may be associated with multiple second applications, in an embodiment, the acquisition program may further perform ordering of the second applications. For example, the second applications may be ranked according to respective degrees of associations with the first application, and these degrees may be manifested by respective numbers of times of switching from the first application to the second applications. In this case, entry information of associated second applications (which is sent by the acquisition program or found by the first application) obtained by the first application may further include ordering information of the second applications. As such, the first application may display respective entry information of the second applications on the entry information window according to this ordering information. In an embodiment, under a circumstance that the first application has reserved multiple entry information windows, a precedence relationship generally exists among the entry information windows. For example, if three entry information windows are reserved and are arranged from top to bottom, an order of precedence from the top to the bottom exists among the three entry information windows, for example. Therefore, after obtaining the order of the second applications, the entry information of the second applications may further be displayed in combination with the ordering relationship of the entry information windows. In an embodiment, the entry information of the second applications may also be placed according to degrees of prominence of the entry information windows. For example, when the entry information windows are not completely the same in size, a large entry information window has a higher degree of prominence than a small entry information window. Furthermore, an entry information window that is in the middle of the running interface has a higher degree of prominence than one that is at the edge. In this case, entry information of a second application that ranks high may be placed in an entry information window having a high degree of prominence.

By using the method of adding entry information to a running interface of an application provided by the third embodiment, the entry information of the second application can be directly displayed in the running interface of the first application in an embedded form, and integrated with other information in the running interface, thus avoiding the blocking of the running interface of the first application by a floating window, for example.

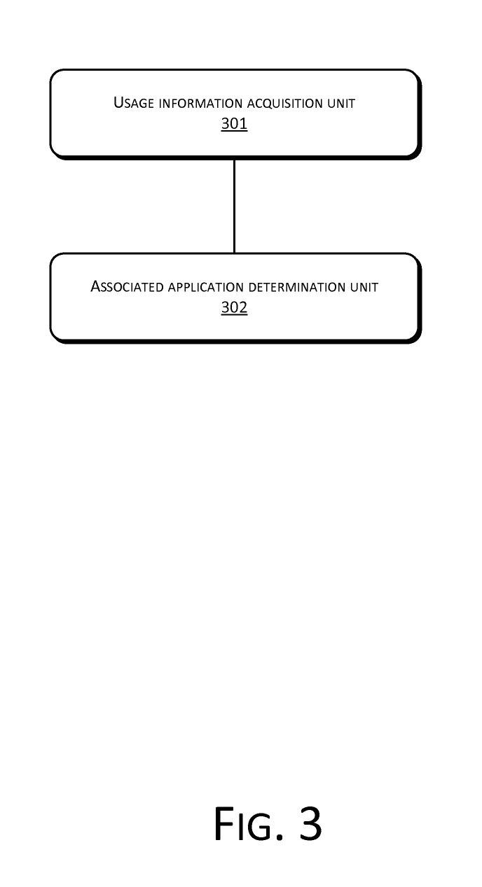

Corresponding to the application switching method of the acquisition program side provided by the embodiment of the present disclosure, the embodiment of the present disclosure further provides an application switching apparatus. As shown in FIG. 3, the apparatus may include:

a usage information acquisition unit 301, used for acquiring usage information of a user for applications installed in a terminal, the applications including one or more first applications and one or more second applications; and

an associated application determination unit 302, used for determining, based on the acquired usage information, a second application that is associated with a first application, so as to add entry information of the associated second application into a running interface of the first application to facilitate running of the second application when the user executes a specified operation on the entry information of the associated second application.

The usage information acquisition unit 301 may be used for:

recording the usage information of the user for the applications, where the usage information for the applications includes respective time information about when the applications are used; and

determining an order of using the applications based on the time information about when the applications are used.

The associated application determination unit 302 may be used for:

determining the second application associated with the first application based on the determined order of using the applications.

Specifically, the associated application determination unit 302 may be used for:

counting respective numbers of times of switching from the first application to the second applications by the user based on the determined order of using the applications; and

determining at least one second application corresponding to first few highest number of times of switching as the second application associated with the first application.

The apparatus further includes:

a first determination unit, used for: prior to counting the respective numbers of times of the user's switching from the first application to the second applications, determining whether a time interval of switching from the first application to a second application is greater than a preset time threshold, and if not, counting the switching. In other words, when the time interval of switching to the second application exceeds the set time threshold, the switching is not ignored.

In addition, the apparatus may further include:

a second determination unit, used for: prior to determining the at least one second application corresponding to the first few highest number of times of switching as the second application associated with the first application, if a corresponding number of times of switching is not less than a set switching threshold, performing the act of determining the at least one second application corresponding to the first few highest number of times of switching as the second application associated with the first application.

In addition, the apparatus may further include:

an association relationship recording unit, used for recording an association relationship between the first application and the second application to facilitate adding the entry information of the associated second application to the running interface of the first application based on the association relationship when the first application is run.

When the entry information is eventually displayed, the apparatus may include:

an embedding unit, used for embedding the entry information of the associated second application into the running interface of the first application.

For this purpose, the apparatus may further include:

an information sending unit, used for sending information of the associated second application to the first application to facilitate the first application to add the entry information of the associated second application to the running interface of the first application; or

an information query unit, used for: when receiving a request for querying the association relationship of the first application, sending the information of the associated second application to the first application to facilitate the first application to add the entry information of the associated second application to the running interface of the first application.

In another implementation, when the entry information is displayed, the following operations may be included:

when obtaining a running event of the first application, creating a floating window above the running interface of the first application; and

adding the entry information of the associated second application to the floating window.

Optionally, the apparatus may further perform:

determining whether to suspend or terminate the first application when switching to the second application based on a characteristic associated with the running of the first application.

In addition, in order to provide more accurate information in a time segment, the associated application determination unit 302 may be used for:

determining the second application associated with the first application within a specified time range based on the acquired usage information, wherein

when the entry information of the associated second application is added to the running interface of the first application, the entry information of the associated second application corresponding to the time range may be added to the running interface of the first application in the specified time range.

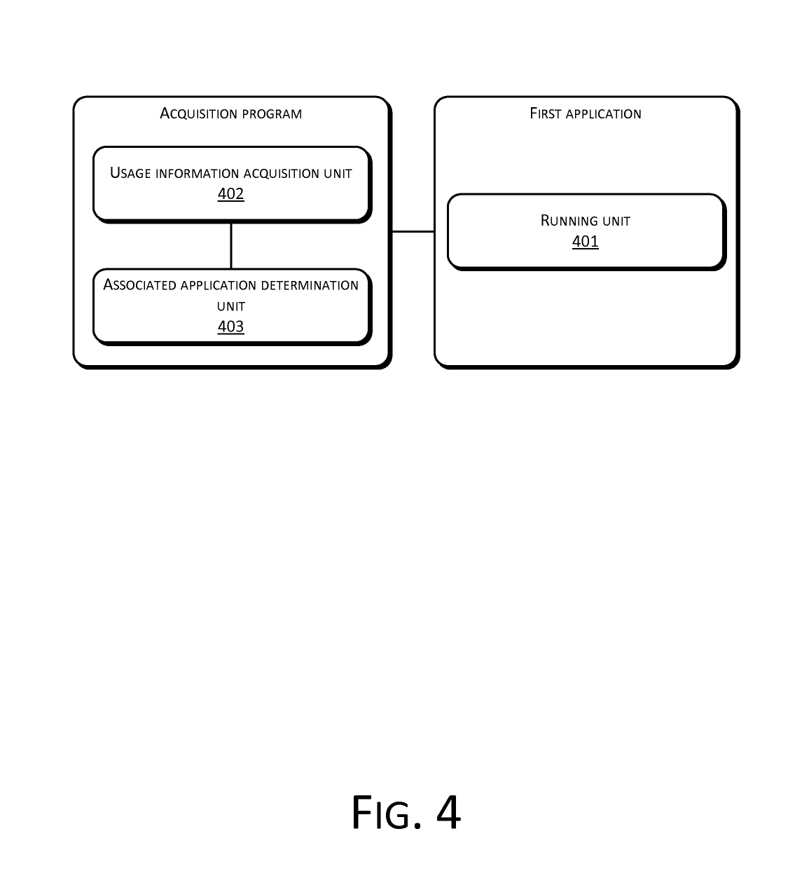

Corresponding to the application switching method provided by the second embodiment of the present disclosure, the embodiment of the present disclosure further provides an application switching apparatus. As shown FIG. 4, the apparatus may include:

a running unit 401, used for running a first application, a running interface of the first application including entry information of a second application that is associated with the first application, so as to facilitate running of the second application when a specified operation is executed on the entry information of the associated second application, where

the second application that is associated with the first application is determined using the following approach:

a usage information acquisition unit 402, used for acquiring usage information of a user for applications installed in a terminal, the applications including the first application and one or more second applications; and

an associated application determination unit 403, used for determining, based on the acquired usage information, the second application that is associated with the first application.

The running unit 401 may be a unit in the first application, and the acquisition unit 402 and the associated application determination unit 403 may be units in an acquisition program.

In a specific implementation, in order to enable the first application to add the entry information of the second application to the running interface of the first application, when the first application is run or at another chance, the first application may receive the information of the second application associated with the first application sent from the acquisition program. When the first application is run, the entry information of the second application associated with the first application is loaded on the running interface of the first application.

Alternatively, the first application sends a query request to the acquisition program, and receives the information of the second application associated with the first application that is returned from the acquisition program. When the first application is run, the entry information of the second application associated with the first application is loaded on the running interface of the first application.

Alternatively, the first application may obtain and store information about an association relationship between the first application and the second application from the acquisition program. When running, the first application may search for the second application associated with the first application from the stored information of the association relationship between the applications, and add the entry information of the found second application that is associated with the first application to the running interface of the first application.

In addition, in correspondence with the method of adding entry information to a running interface of an application provided by the third embodiment of the present disclosure, the embodiment of the present disclosure further provides an apparatus of adding entry information to an application running interface, where one or more entry information windows are reserved on a running interface of a first application, and the apparatus is used for adding entry information of at least one second application associated with the first application to the entry information windows, where the at least one second application associated with the first application is determined based on an order of use of the first application and the second application by a user.

When multiple second applications exist, the second applications are ordered based on usage information associated with the second applications; and

adding the entry information of the at least one second application associated with the first application to the entry information windows includes:

adding the entry information of the at least one second application that is associated with the first application and has a highest rank to the entry information windows.

In short, when a user uses a first application, the application switching apparatus provided by the embodiment of the present disclosure may determine a second application associated with the first application in a process of using applications by the user, and provide an entry of the second application in a running interface of the first application. In this way, if the user wants to use the second application and run the second application after using the first application, the user can directly switch to the second application via the entry displayed in the running interface of the current first application, without the need of performing an operation such as switching to a home screen or desktop of an operating system, thus avoiding to perform a search from among various application icons on the home screen or desktop. This saves operation time for the user and also reduces power consumption of a terminal device.

As can be seen from the description of the foregoing implementations, one skilled in the art can clearly understand that the present disclosure may be implemented using software and a universal hardware platform as needed. Based on such understanding, the substance of the technical solutions of the present disclosure or the portions contributing to the existing technologies may be implemented in the form of a software product. This computer software product may be stored in a storage medium, such as a ROM/RAM, a magnetic disk or an optical disk, which includes instructions for causing a computing device (which may be a personal computer, a server, or a network device, etc.) to perform the embodiments or a certain portion of acts of an embodiment of the present disclosure.

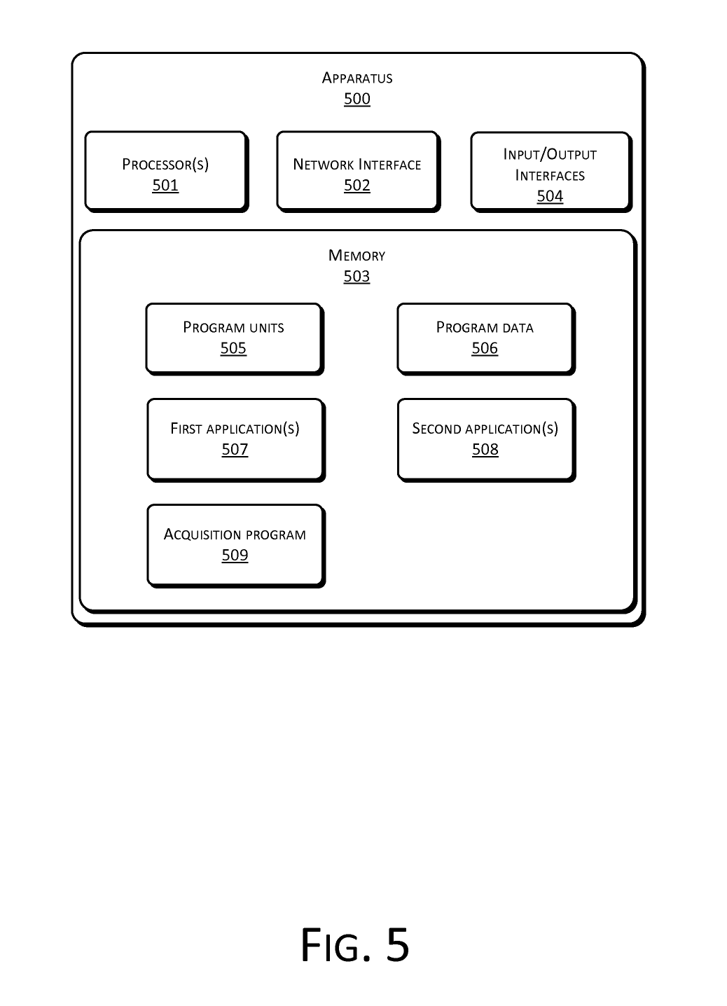

For example, FIG. 5 shows an example apparatus 500, such as the apparatus as described above, in more detail. In one embodiment, the apparatus 500 may include, but is not limited to, one or more processors 501, a network interface 502, memory 503 and an input/output interface 504.

The memory 503 may include computer-readable media in the form of volatile memory, such as random-access memory (RAM) and/or non-volatile memory, such as read only memory (ROM) or flash RAM. The memory 503 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 503 may include program units 505 and program data 506. In one embodiment, the memory 503 may further include one or more first applications 507, one or more second applications 508 and an acquisition program 509. Details about these applications, programs and program units may be found in the foregoing embodiments described above.

The embodiments in this disclosure are described in a progressive manner. Same or similar parts of the embodiments may be mutually referenced to one another, with a focus of each embodiment being different from other embodiments. In particular, with respect to the system or the system embodiment, the description thereof is relatively simple due to their resemblance to the method embodiments, and an associated part may be referenced to a respective portion of the description of the method embodiments. The system or system embodiment described above is merely exemplary. The units described as separate components may or may not be physically separated. Components displayed as units may or may not be physical units, i.e., may be located in a single location or may be distributed among multiple network units. A part or all of the modules may be selected to achieve the objectives of the solutions of the embodiments according to actual needs. One of ordinary skill in the art may understand and implement the embodiments without paying creative efforts.

The methods and apparatuses of switching applications and adding entry information that are provided by the present disclosure have been described in detail above. The principles and implementations of the present disclosure are described using specific examples in this disclosure. The description of the embodiments are merely intended to help understanding the methods and core concepts of the present disclosure. Meanwhile, for one of ordinary skill in the art, changes may be made to the specific implementations and application scopes based on the concepts of the present disclosure. In short, the content of this specification shall not be construed as a limitation to the present disclosure.

What is claimed is:

1. An application switching method comprising:
acquiring usage information of a user for applications installed in a terminal, the applications include one or more first applications and one or more second applications; and
determining a second application that is associated with a first application based on the acquired usage information, so as to add entry information of the associated second application into a running interface of the first application to facilitate running of the second application when the user executes a specified operation on the entry information of the associated second application.

2. The method of claim 1, wherein acquiring the usage information of the user for the applications installed in the terminal comprises:
recording the usage information of the user for the applications, where the usage information for the applications includes respective time information about when the applications are used; and
determining an order of using the applications based on the time information about when the applications are used, wherein determining the second application that is associated with the first application based on the acquired usage information comprises determining the second application associated with the first application based on the determined order of using the applications.

3. The method of claim 2, wherein determining the second application associated with the first application based on the determined order of using the applications comprises:
counting respective numbers of times of the user's switching from the first application to the second applications based on the determined order of using the applications; and
determining at least one second application corresponding to first few highest number of times of switching as the second application associated with the first application.

4. The method of claim 3, wherein prior to counting the respective numbers of times of the user's switching from the first application to the second applications, the method further comprises: determining whether a time interval of switching from the first application to a second application is greater than a preset time threshold, and if not, counting the switching.

5. The method of claim 3, wherein prior to determining the at least one second application corresponding to the first few highest number of times of switching as the second application associated with the first application, the method further comprises:
if a corresponding number of times of switching is not less than a set switching threshold, performing the act of determining the at least one second application corresponding to the first few highest number of times of switching as the second application associated with the first application.

6. The method of claim 1, further comprising:
for recording an association relationship between the first application and the second application to facilitate adding the entry information of the associated second application to the running interface of the first application based on the association relationship when the first application is run.

7. The method of claim 6, wherein adding the entry information of the associated second application into the running interface of the first application comprises:
embedding the entry information of the associated second application into the running interface of the first application.

8. The method of claim 7, wherein embedding the entry information of the associated second application into the running interface of the first application comprises:
sending the information of the associated second application to the first application to facilitate the first application to add the entry information of the associated second application to the running interface of the first application; or
when receiving a request for querying the association relationship of the first application, sending the information of the associated second application to the first application to facilitate the first application to add the entry information of the associated second application to the running interface of the first application.

9. The method of claim 6, wherein adding the entry information of the associated second application into the running interface of the first application comprises:
when detecting a running event of the first application, creating a floating window above the running interface of the first application; and
adding the entry information of the associated second application to the floating window.

10. The method of claim 1, further comprising:
determining whether to suspend or terminate the first application when switching to the second application based on a characteristic associated with the running of the first application.

11. The method of claim 1, wherein acquiring the usage information of the user for the applications installed in the terminal comprises acquiring information of a time range in which the user uses the applications, and determining the second application that is associated with the first application based on the acquired usage information comprises:
determining the second application associated with the first application within a specified time range based on the acquired usage information; and
adding entry information of the associated second application into the running interface of the first application comprising adding the entry information of the associated second application corresponding to the specified time range to the running interface of the first application in the specified time range.

12. One or more computer storage media storing executable instructions that, when executed by one or more processors, cause the one or more processors to perform acts comprising:
running a first application, a running interface of the first application including entry information of a second application that is associated with the first application for facilitating running the second application when a specified operation is executed on the entry information of the associated second application, wherein:
the second application that is associated with the first application is determined by:
acquiring usage information of a user for applications installed in a terminal, the applications including the first application and one or more second applications; and
determining, based on the acquired usage information, the second application that is associated with the first application.

13. The one or more computer storage media of claim 12, the acts further comprising:
receiving, by the first application, information of the second application associated with the first application sent from a monitoring program; and
when the first application is run, loading, into the running interface of the first application, the entry information of the second application associated with the first application.

14. The one or more computer storage media of claim 12, the acts further comprising:
sending, by the first application, a query request to a monitoring program, and receiving information of the second application associated with the first application that is returned from the monitoring program; and
when the first application is run, loading, into the running interface of the first application, the entry information of the second application associated with the first application.

15. The one or more computer storage media of claim 12, wherein the running interface of the first application including the entry information of the second application that is associated with the first application comprises:
searching for the second application associated with the first application from stored information of an association relationship between the applications; and
adding the entry information of the found second application associated with the first application into the running interface of the first application.

16. The one or more computer storage media of claim 12, the acts further comprising:
detecting the specified operation on the entry information of the associated second application; and
switching from the first application to the associated second application.

17. The one or more computer storage media of claim 16, the acts further comprising: terminating or suspending the first application after switching to the associated second application.

18. An apparatus comprising:
one or more processors; and
memory storing executable instructions that, when executed by the one or more processors, cause the one or more processors to perform acts comprising:
reserving one or more entry information windows on a running interface of a first application; and
adding entry information of at least one second application that is associated with the first application to an entry information window, wherein the at least one second application that is associated with the first application is determined based on an order of using the first application and the second application by a user.

19. The apparatus of claim 18, the acts further comprising:
when multiple second applications exist, ordering the second applications according to usage information of the second applications; and
adding the entry information of the at least one second application associated with the first application to the entry information window comprising adding, to the entry information window, the entry information of at least one second application that is associated with the first application and has a highest ranking.

20. The apparatus of claim 18, wherein the entry information window comprises a floating window.
